(19) United States
(12) Patent Application Publication
(10) Pub. No.: US 2003/0156774 A1
(43) Pub. Date: Aug. 21, 2003

(54) Unipolar electrical to bipolar optical converter

(76) Inventor: Jan Conradi, Corning, NY (US)

Correspondence Address: CORNING INCORPORATED, SP-TI-3-1, CORNING, NY, 14831

(21) Appl. No.: 10/077,525

(22) Filed: Feb. 15, 2002

(51) Int. Cl. G02F 1/035

(52) U.S. Cl. 385/2; 385/3

(57) ABSTRACT

An optical amplitude modulator (16) has a first input (13) for receiving a continuous optical signal, a second input (17) for receiving a bipolar data encoded electrical signal, and a Mach-Zehnder interferometer transfer operation biased at V_{π} for modulating the continuous signal based on the bipolar data encoded electrical signal for generating an AMI modulated optical signal having three electric field levels, +/−E and 0, and two power levels, 0 and P, such that the resultant modulated signal is both amplitude and phase modulated.

### BACKGROUND OF THE INVENTION

1. Field of the Invention

The present invention relates generally to optical transmission, and particularly to an optical transmission system which reduces the optical signal bandwidth of a Return-to-Zero (RZ) signal and reduces the base-band electrical signal bandwidth in an optical transmitter using RZ modulation.

2. Technical Background

Until recently, most fiber optic communications systems employed Non-Return-to-Zero (NRZ) modulation in which each logical bit or pulse was transmitted as a pulse whose pulse width was equal to the full bit period, T=1/B, where B is the bit rate at which pulses are transmitted. More recently, it has been shown that Return-to-Zero or RZ signaling provides better performance in terms of reduced degradation of dense wavelength division multiplexed (DWDM) system performance due to fiber non-linearities such as four wave mixing (FWM) and cross-phase modulation (XPM).

RZ modulation can be implemented in a variety of known different binary signaling formats, which all have significantly different optical transmission spectra. Of these formats, unipolar RZ or single-phase RZ (RZ-SP) is the most straight forward to implement in optical fiber transmission systems, although what has become known as RZ with alternating phase (RZ-AP or AP-RZ) or optical carrier-suppressed RZ (CS-RZ) and chirped RZ-AP (CRZ-AP) have also been implemented.

A three Mach-Zehnder (MZ) modulator structure to generate RZ with alternating phase is known. A first modulator is a Mach Zehnder modulator biased at zero volts with a first input provided by a continuous optical signal from an optical source. At a second input of the first modulator, an electrical sinusoidal clock voltage is applied whose voltage varies between 0 and V_{π}. This first modulator thus generates a train of RZ optical pulses centered in frequency at the optical carrier frequency, and whose repetition frequency is equal to the transmission bit rate B. A second modulator is also a Mach Zehnder modulator biased at zero volts for receiving the RZ pulse train from the first modulator. At the second input of the second modulator, the NRZ data voltage varies between 0 and V_{π}, for driving the second modulator in a push-pull configuration to generate a chirp free signal. The third modulator is a Mach Zehnder modulator biased at V_{π}, for receiving the chirp free signal from the second modulator. At the second input of the third modulator, the sinusoidal clock voltage of a clock signal at B/2 phase modulates the chirp free signal of the second modulator and causes the phase of alternating bits to change.

Hence, in this alternating phase variation of RZ, the phase of the optical carrier is reversed every bit period using a Mach-Zehnder modulator biased at extinction (Vdc=V_{π}) and driven by a sinusoidal clock whose frequency is B/2. This suppresses the normally present light at the optical carrier frequency and alternates the phase of the optical electric field on each bit, but it also introduces additional tones on both sides of the optical carrier frequency, and the tones are separated from the carrier frequency by B/2.

These two formats of SP and AP, along with two RZ versions of duobinary signaling formats have been compared for their (simulated) transmission performance in one specific dispersion managed cable configuration. In this comparison, one version of duobinary RZ (Modified Duobinary RZ) provided up to 2dBQ improvement over ordinary RZ, while AP-RZ gave up to 1.5 dBQ improvement. By comparing the signal spectra associated with these formats, the conclusion was reached that the performance benefit associated with AP-RZ came about through a combination of the absence of an unmodulated optical carrier, and the alternating phase on consecutive bits, and in the case of the duobinary formats because of reduced spectral width and the absence of the unmodulated carrier. However, AP- RZ still has tones in its frequency spectrum which could contribute to further non-linear interchannel performance degradation as well as intra-channel four wave mixing.

It is known in digital signaling that bipolar RZ, also known as Alternate MARK Inversion (AMI) has no tones at all, and a signal spectrum that is intermediate between duo-binary and AP-RZ. Because of the narrower signal spectrum than normal single phase RZ-SP or alternative phase AP-RZ, the bipolar RZ format improves system spectral efficiency for digital systems.

Therefore there is a need to implement the bipolar RZ format in an improved and simple optical modulator structure to provide the improved transmission benefit of a more efficient optical spectral system.

It is also known that both the duobinary and the AP-RZ formats have two optical electric field phase states +/−E that represent logical ONEs or MARKs, that both have the same optical power level P. When these signals are detected by the usual PIN photodiodes, which respond to the optical power, no discernable difference between the two states results, so that detection is quite simple.

### SUMMARY OF THE INVENTION

One aspect of the invention is an optical amplitude modulator having a first input for receiving a continuous optical signal, and a second input for receiving a bipolar data encoded electrical signal. This amplitude modulator can be a Mach-Zehnder modulator biased at V_{π}, for modulating the continuous signal based on the bipolar data encoded electrical signal for generating an AMI modulated optical signal having three electric field levels, +/−E and 0, and two power levels, 0 and P, such that the resultant modulated signal is both amplitude and phase modulated.

In another aspect, the present invention includes alternate MARK inversion (AMI) encoding and converting an NRZ unipolar signal to an RZ bipolar signal or to an NRZ bipolar signal.

Additional features and advantages of the invention will be set forth in the detailed description which follows, and in part will be readily apparent to those skilled in the art from that description or recognized by practicing the invention as described herein, including the detailed description, the claims, as well as the appended drawings which follow.

It is to be understood that both the foregoing general description and the following detailed description of the present embodiments of the invention, are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

FIG. 1 is a schematic view of one embodiment of the present invention;

FIG. 2A-B are transfer function graphs of the operation of the modulator 16 of FIG. 1, in accordance with the teachings of the present invention;

FIG. 3 is a known NRZ logic block diagram of one embodiment of the encoder 24 of FIG. 1;

FIG. 4 is an RZ modified logic block diagram of a second embodiment of the encoder 24 of FIG. 1 to provide an RZ-AMI output, in accordance with the teachings of the present invention; and

FIG. 5 is an NRZ to RZ modified logic block diagram of a second embodiment of the encoder 24 of FIG. 4 to provide an RZ-AMI output, in accordance with the teachings of the present invention.

### DETAILED DESCRIPTION OF THE PREFERRED EMBODIMENTS

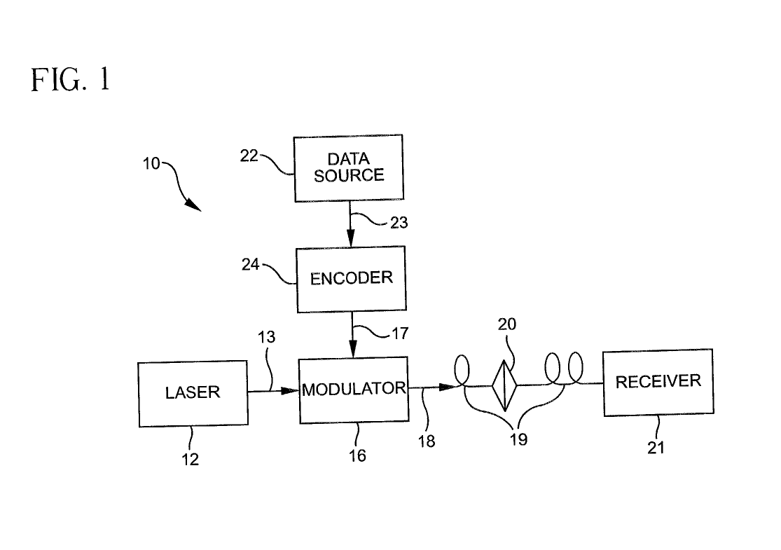

Reference will now be made in detail to the present preferred embodiments of the invention, examples of which are illustrated in the accompanying drawings. Whenever possible, the same reference numerals will be used throughout the drawings to refer to the same or like parts. One embodiment of the electrical to optical converter for alternate MARK inversion (AMI) or bipolar optical transmission of the present invention is shown in FIG. 1, and is designated generally throughout by the reference numeral 10. Bipolar or AMI will be used interchangeably to denote the same coding since both terms are used in the electrical communication art.

Referring to FIG. 1, an optical transmitter in a lightwave transmission system 10 includes a laser 12 for generating a continuous optical signal, or DC light output optical beam carried by an optical fiber for reception on an optical input 13. An encoder 24, preferably in the form of a bipolar electrical coder for alternating the amplitude polarity of consecutive MARK pulses of a data encoded electrical signal from a data source 22 generates a bipolar data encoded electrical signal on an electrical input lead 17. An electrical to optical converter, preferably in the form of a modulator 16, has the optical input 13 for receiving the continuous optical signal, the electrical input 17 for receiving the bipolar data modulated electrical signal, and an optical output 18 for receiving the AMI modulated optical signal based on the bipolar data encoded electrical signal which is transmitted along lengths of an output optical fiber 19 spanning the distance to a receiver 21. Typically, an optical amplifier 20, such as an Erbium Doped Fiber amplifier (EDFA) may be provided to amplify the modulated light as it propagates along the lengths of the optical fiber 19.

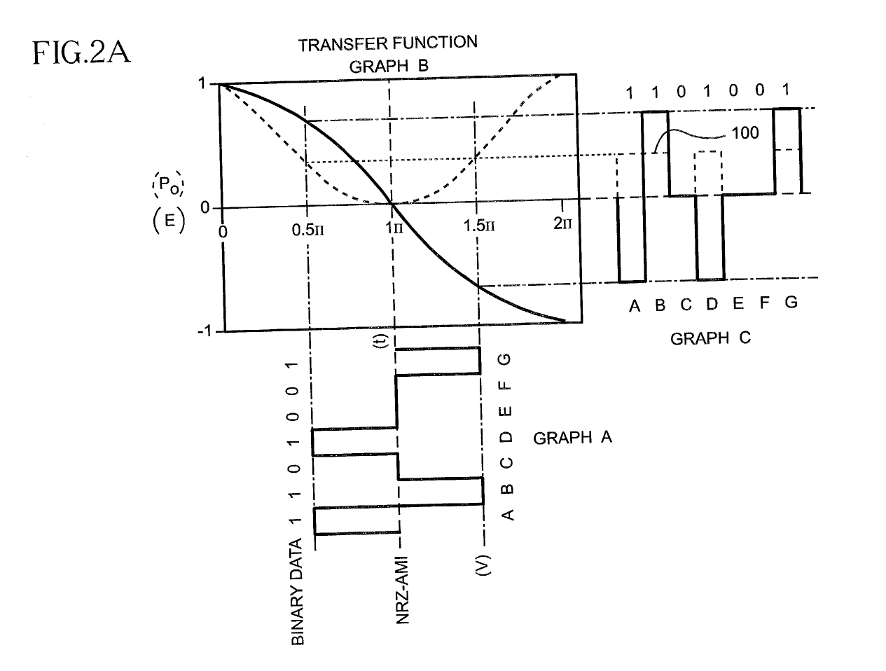

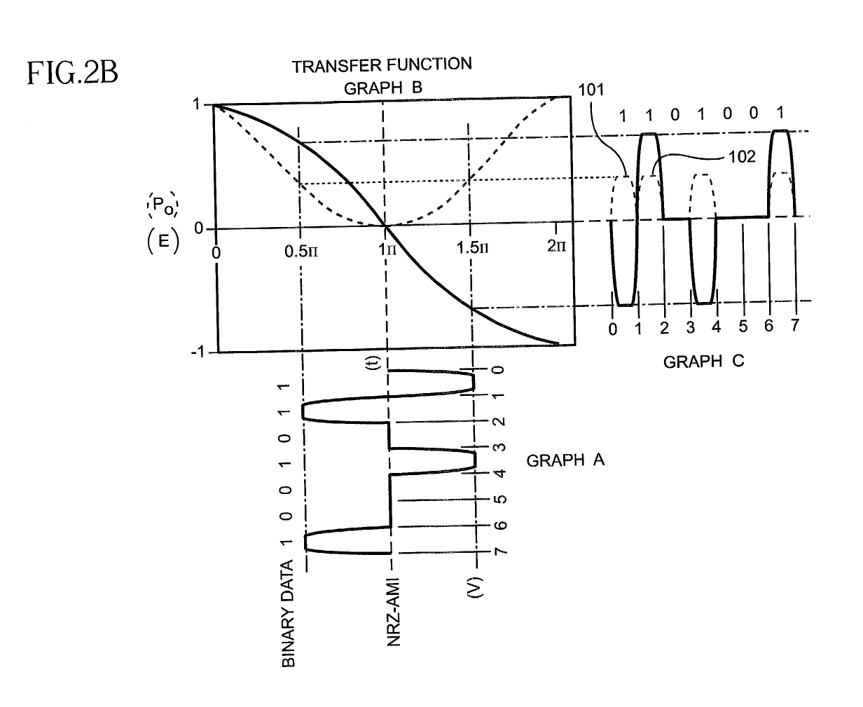

As seen in FIG. 2, the AMI modulated optical signal has three electric field levels, +/−E and 0, and two power levels, 0 and P, when the bipolar data modulated electrical signal is applied to the electrical to optical converter to amplitude modulate the electric field. The alternate electric fields of +E and −E are a form of phase-shift keying.

As embodied herein and depicted in FIG. 1, the modulator 16 is defined by an electrical to optical converter and specifically a Mach-Zehnder interferometer modulator or any other suitable optical amplitude modulator structure implementation that will provide a bipolar-RZ or NRZ optical signal, given a bipolar RZ or NRZ data encoded electrical voltage stream. This single modulator is preferably a known Mach Zehnder (Mz) modulator biased at V_{π} for receiving the continuous optical signal source, such as from the laser 12, and being driven, preferably in a push-pull configuration, by a bipolar data encoded voltage stream whose maximum voltage varies between +/−V_{π}. By V_{π}, is meant the differential voltage applied between the two arms of a MZ modulator that results in a π radian phase shift in the light exiting the two arms; this results, in the ideal case, in complete extinction of the light exiting the modulator, as shown in FIG. 2. This single modulator 16 generates a train of RZ or NRZ pulses at the transmission bit rate B to provide a suppressed optical carrier signal. It is known that the difference between amplitude and intensity (or power) modulation can be a bit subtle. Intensity modulation, commonly also referred to as On-Off Keying (OOK) simply turns the light source On and Off—as in turning a flash light on and off; no use is made of the phase of the light. Amplitude modulation, on the other hand, refers to changing the amplitude of the electric field in some specific manner, and in fact during the process, the light can be turned “ON” and “OFF” giving rise to OOK. However, in the case of AMI (and duo-binary) modulation the electric field is amplitude modulated in a very specific way such that the phase of the electric field changes in a specific way at the same time. To achieve the very specific phase properties needed for AMI and duobinary when a MZ modulator is used, the MZ is biased at V_{π}, such that when the electrical signal is applied, the phase of the light undergoes a π phase change as the signal voltage swings either side of V_{π}. A phase modulator on the other hand changes ONLY the phase of the light without changing its amplitude at the same time; the amplitude remains constant throughout.

The single Mach-Zehnder (MZ) modulator 16 thus receives the continuous optical signal source at the first input 13 of FIG. 1 and is driven by the NRZ or RZ bipolar data encoded signal, also called an NRZ or RZ Alternate MARK Inversion (NRZ-AMI or RZ-AMI) signal at the second input 17. Because this single MZ modulator 16 is biased at V_{π}, which is the same as biasing at extinction, then by applying the NRZ or RZ bipolar data encoded voltage stream, at the second input of the second MZ modulator 17, with a voltage whose maximum signal swing varies between +/−V_{π}, for driving the single modulator 16 in a push-pull configuration, a chirp free output signal is generated which is an AMI or bipolar optical signal for transmission in an amplitude modulated form. An advantageous feature of the AMI optical signal is that it is usually detected by a square-law PIN photodetector, which will decode both of the electrical field levels of +E or −E as a digital ONE or MARK pulse because the optical power or optical intensity of the pulses with electric field levels +/−E is the same resulting in identical output photocurrent pulses from the PIN photodetector.

The alternate phases will provide improved transmission performance. Work with other modulation formats, such as modified duobinary, suggests that alternating the phase of bits helps to reduce non-linear impairments in optical fiber transmission systems. Also, having no unmodulated light at various “tones” reduces inter-channel four wave mixing (FWM) in dense wavelength division multiplexed (DWDM) systems, as well as reduces intra-channel FWM in very high bit rate systems. AMI has both of these characteristics and can be generated with a single modulator. Modified duobinary has some of these characteristics and simulations show it works well, but typically is more complex to implement, even when a single modulator is used.

In the embodiment of FIG. 1, the optical pulse shapes of the AMI or bipolar output signal for transmission in an amplitude modulated form are determined partly by the bipolar coder or encoder 24 that generates the data encoded voltage input pulse train. Specifically, the optical pulse shape is determined both by the shape of the RZ or NRZ bipolar signal output from the logic circuit of the encoder 24 along with the transfer function of the MZ modulator, as seen in FIG. 2, and any drive electronics in between.

Referring to FIGS. 2A-2B, two transfer functions are represented for the AMI converter showing voltage waveforms and resultant optical electric field and optical power waveforms when the voltage waveform has a finite rise and fall time, as in FIG. 2B, and when the voltage waveform is perfectly square (zero rise and fall time), as in FIG. 2A. Thus, in FIG. 2A, the relation or transfer characteristics between the driving voltage, and the idealistic square optical pulses generated by the modulator 16 are represented as the transfer function of the modulator 16 of FIG. 1. Graph A shows a drive voltage in a bipolar format, such as an NRZ bipolar format, for example, on a graph of voltage (V) versus time (t). Graph B shows the transfer characteristic function of the modulator 16 on a graph of optical power (Po represented by dashed lines) versus voltage (V) and optical electric field (E represented by a bold line) vs. voltage. Graph C shows the corresponding optical pulse output of the modulator 16 in NRZ format on a graph of optical power (Po) versus time (t), and optical electric field vs. time. FIG. 2A thus shows how the single-stage Mach-Zehnder based AMI modulator 16 is driven with the +/−V, 0 voltage levels, giving rise to the corresponding three electric field levels +/−E, 0. The letters in Graph A are simply intended to label each bit for ease of identification and correspondence between the example data voltage stream and the optical transmission stream.

Basically, either a low voltage (−V) or a high voltage (+V ) in the drive voltage of Graph A sweeps the optical power output shown in Graph B through the same maximum optical power levels, generating an optical pulse. The high voltage level (+V) or low voltage level (−V) correspond to MARK pulses or ONEs (“1”) in the data stream while a midlevel voltage level, normally at 0 voltage, corresponds to a “0”in the data stream. The modulator 16 of FIG. 1 is of a type, such as an MZ interferometer biased at V_{π}, which has a maximum MARK optical output pulse (1) at a first voltage driving level +V, a maximum MARK optical output pulse (1) at a second voltage driving level −V, a minimum optical output (0) at a voltage level (0) between the first and second voltage driving level and the phase of every maximum MARK optical output pulse is inverted alternately corresponding to the transfer function characteristics of FIG. 2.

Hence, in accordance with the invention, the present invention for a method of converting a unipolar voltage data stream into a bipolar optical data stream includes a first step of supplying a continuous optical signal to a modulator, wherein the modulator has a maximum MARK optical power output at a first voltage driving level +V, a maximum MARK optical power output at a second voltage driving level −V, a minimum optical power output at a voltage level (0) between the first and second voltage driving level and the phase of every maximum MARK optical output pulse is inverted alternately by π radians. A second step includes encoding a unipolar voltage data stream to provide an encoded bipolar voltage data stream. A third step includes driving the modulator with the encoded bipolar voltage data stream to generate a bipolar optical power data stream such that there will be a minimum optical power output when the encoded bipolar voltage data stream stays at a midlevel between the first and the second voltage level.

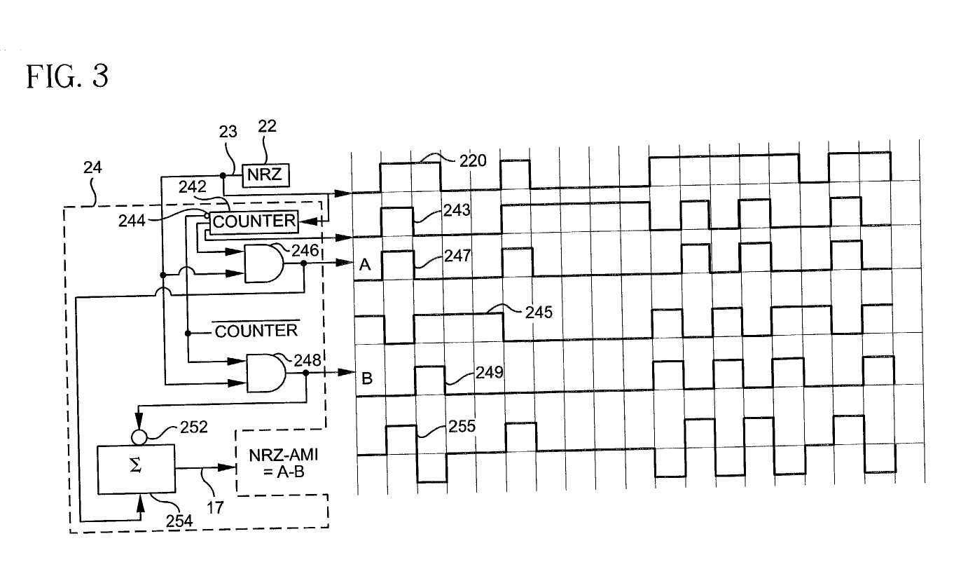

The generation of a bipolar signal from an NRZ unipolar signal can be carried out with a known digital logic circuit as shown in FIG. 3 or with other equivalent converters, coders, encoders or translating circuits. The NRZ-AMI output 17 from the logic circuits of FIG. 3 drives the single MZ modulator 16 of FIG. 1 at the input 17 for outputting an NRZ bipolar optical signal to be transmitted.

FIG. 2B represents the transfer characteristics between the driving voltage, and the realistic rounded optical pulses generated by a practical modulator 16 and a practical encoder 24 of FIG. 1. Practical implementation of the NRZ-AMI encoder 24 of FIG. 1 in electrical form, will in fact result in pseudo RZ-AMI in optical form. Because of band-limiting on the electrical signal by electrical circuits having a limited bandwidth and the MZ modulator itself having limited bandwidth, the electrical signal edges will have finite rise and fall times, as in a sinusoidal pulse instead of a perfect square-wave pulse, creating a pseudo-RZ electrical signal. Thus the NRZ-AMI encoder having a limited bandwidth for converting the NRZ-AMI bipolar data modulated electrical signal in electrical form with finite rise and fall times at the electrical input causes a pseudo RZ modulated optical signal in optical form at the optical output of the modulator 16 of FIG. 1. The term “pseudo-RZ” used in this patent application refers to a MARK pulse returning to zero or any flipping of polarity when two consecutive “ONEs” or “MARKS” are encountered. For example, two “ONEs” in sequence in the typical unipolar NRZ input data or even the idealistic bipolar NRZ data will look like one single idealistic square output power pulse 100 in FIG. 2A. However, after applying this pseudo “single” unipolar pulse into the AMI encoder 24, two “pseudo” pulses 101 and 102 result, as seen in FIG. 2B, which look like a pseudo return-to-zero pulse because “zero” is reached in between the two “ONEs” because of the rounding of edges of the first and second output power pulse from the bandlimiting of the data signal. Bandlimited NRZ bipolar input signals thus generate RZ-AMI optical signals providing the advantageous spectral characteristics of both the modified duobinary signals and AP-RZ signals that result in improved (simulated) transmission characteristics when compared with ordinary RZ.

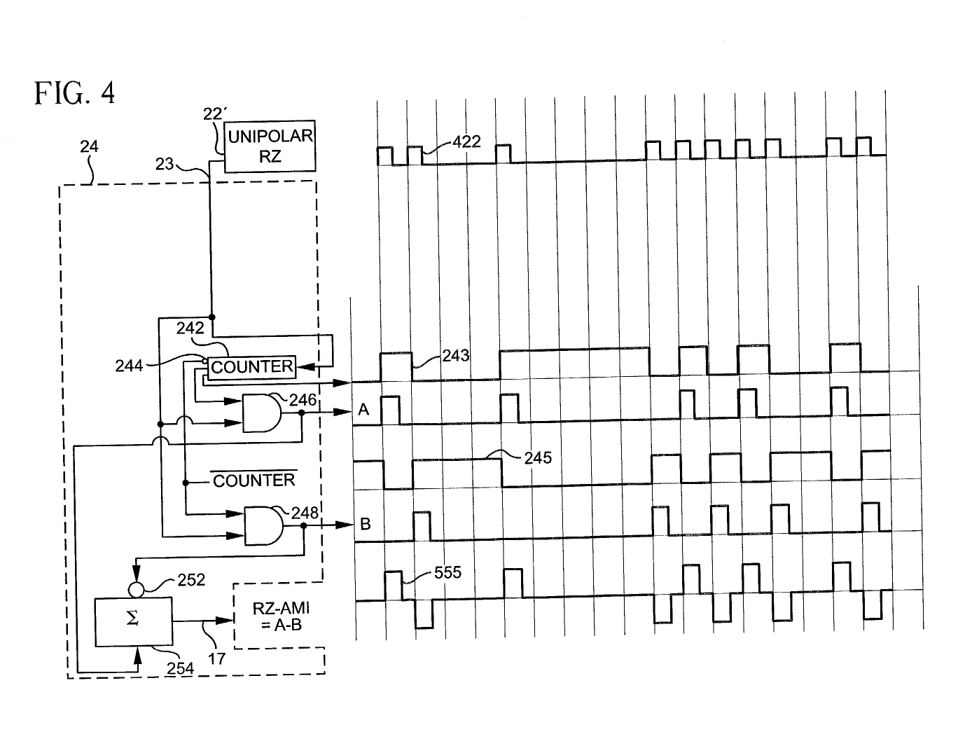

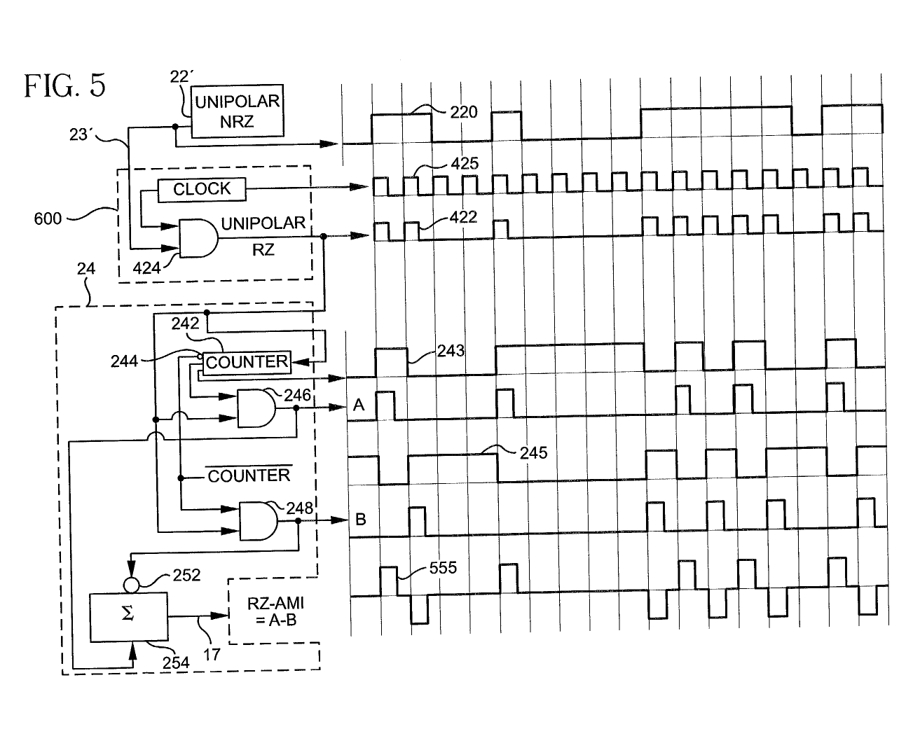

Referring to FIG. 3, the bipolar electrical coder 24 of FIG. 1 can be of the type shown on page 278 in David R. Smith's book entitled “Digital Transmission Systems”, second edition published by Van Nostrand Reinhold in New York. As discussed already, such digital transmission system coders are already known for electrical communications, such as for T1 systems using copper wires but applying these to optical transmissions has not been shown and might have been forgotten. According to the teachings of the present invention, two variations on Smith's coder can be used for optical communications. These variations being the two versions that generate RZ-AMI with either direct RZ input signals, as shown in FIG. 4, or adding an optional AND gate at the input of the coder, as shown in FIG. 5.

Applying the bipolar electrical encoder to the optical setting, FIG. 3 includes an input terminal 23 for receiving a unipolar NRZ (non-return-to-zero) data encoded electrical signal 220 having a MARK pulse represented by a high level voltage and an absence of a MARK pulse, also known as a SPACE, by a zero voltage. A one-bit counter 242 connected to the input terminal 23 receives the NRZ (non-return-to-zero) data encoded electrical signal 220 and provides a counter signal 243 having a level inversion from a previous state to an alternate state of the zero voltage or the high level voltage, every time a MARK pulse is encountered and remaining at the previous state during the absence of a MARK pulse, such first counter pulse rises from the zero voltage to the high level voltage from a zero voltage start during the first presence of a MARK pulse. An inverter or inverted output 244 of the counter 242 provides an inverted counter output of the counter signal such that the inverted counter signal 245 has a level inversion from a previous state to an alternate state of the zero voltage or the high level voltage, every time the MARK pulse is encountered and remaining at the previous state during the absence of the MARK pulse, such the first inverted counter pulse falls from the high level voltage to the zero voltage from a high level voltage start during the first absence of the MARK pulse. The input terminals of a first AND gate 246 are connected to the output terminal 23 of the signal source 22 and the output 243 of the counter 242 for ANDing the NRZ (non-return-to-zero) data encoded electrical signal 220 with the counter signal 243 to provide an odd pulse ANDed signal 247 where only the odd pulses of the NRZ (non-return-to-zero) data encoded electrical signal are represented by a pulse. A second AND gate 248 is connected to the output terminal 23 of the signal source 22 and the inverted output 244 of the counter 242 for ANDing the NRZ (non-return-to-zero) data encoded electrical signal 220 with the inverted counter signal 245 to provide an even pulse ANDed signal 249 where only the even pulses of the NRZ (non-return-to-zero) data encoded electrical signal are represented by a pulse. A second inverter 252 or an inverted output of the second AND gate 248 changes the polarity of the even pulse ANDed signal 249 such that the original positive-rising even pulse is represented by a negative falling pulse from the zero voltage to a negative high level voltage to provide a negative even pulse ANDed signal. A summer 254 adds the odd pulse ANDed signal 247 with the negative even pulse ANDed signal or an inverted version of signal 249 to provide the bipolar data encoded electrical signal 255 as an NRZ-AMI signal having the three electric voltage levels, +/−V and 0. Hence, the encoding steps convert an NRZ unipolar signal to an NRZ bipolar signal.

Referring to FIG. 4, a unipolar RZ input signal 22′ is applied to the input terminal 23 of FIG. 3, instead of the unipolar NRZ signal 22 to provide an RZ-AMI output signal on the electrical input 17 of FIG. 1. The rest of the logic circuits of FIG. 3 remains the same and is duplicated in FIG. 4. The encoder 24 of FIG. 1 is thus implemented as a unipolar RZ to AMI-RZ encoder using a unipolar RZ signal 422 at the data or signal source 22′. FIG. 4 shows one possible implementation of an RZ bipolar signal, which is appropriate for a bipolar coder 24 where a unipolar RZ data encoded pulse train 422 has already been created or otherwise data encoded in the signal or data source 22′ of FIG. 1. The use of a prime representation (′) is to highlight a different format in signaling but the same type of circuitry block still applies. The input terminal or output terminal 23 of the signal source 22′ receives the unipolar RZ (return-to-zero) data encoded electrical signal 422 having a MARK pulse represented by a high level voltage at half or some other fraction of the bit period and a zero voltage at the rest of the bit period (B) and an absence of a MARK pulse by the zero voltage. The rest of the encoder 24 of FIG. 4 is the same as in FIG. 3 such that an RZ-AMI signal 555 having the three electric voltage levels, +/−V and 0. Hence, the encoding step uses alternate MARK inversion (AMI) encoding which can convert an RZ unipolar signal to an RZ bipolar signal.

Referring to FIG. 5, the encoder 24 of FIG. 1 is implemented as a unipolar NRZ to AMI-RZ encoder. Instead of using the unipolar RZ signal 22′ of FIG. 4 as the input signal on the input terminal 23 of FIG. 4, an optional NRZ to RZ converter logic block 600 is additionally inserted at the input terminal 23 of FIG. 4 to convert an NRZ signal 220 from the data source 22′ to the RZ signal 422 expected at the input terminal 23 of FIG. 4. As one embodiment of the NRZ to RZ converter, an optional AND gate 424 is used in addition to the encoder 24 of FIGS. 3-4 for receiving the unipolar NRZ signal 220 at the new input terminal 23′. Thus an NRZ input with a clocked AND gate 424 provides the expected RZ input 422 to the logic circuit of FIG. 3 and FIG. 4 to generate the RZ-AMI output signal on the electrical input 17 of FIG. 1.

The optional AND gate 424 is synchronized by a clock signal 425 at one input at a bit rate B for sampling a second input provided by the NRZ data encoded voltage stream 220 for generating a train of RZ pulses 422 synchronized at the transmission bit rate B. The output of the AND gate 424 is “high” whenever the two inputs are also “high”. The input terminal 23 now receives the unipolar RZ (return-to-zero) data encoded electrical signal 422 having a MARK pulse represented by a high level voltage at half the bit period and a zero voltage at the other half of the bit period (B) and an absence of a MARK pulse by the zero voltage. The rest of the encoder 24 of FIG. 5 is the same as in FIG. 3 and FIG. 4 such that the same RZ-AMI signal 555 of FIG. 4 has the three electric voltage levels, +/−V and 0. Hence, the encoding step uses alternate MARK inversion (AMI) encoding to convert an NRZ unipolar signal to an RZ bipolar signal.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

What is claimed is:

1. An optical amplitude modulator comprising:
a first input for receiving a continuous optical signal;
a second input for receiving a bipolar data encoded electrical signal; and
a Mach-Zehnder modulator biased at V_{π} for modulating the continuous signal based on the bipolar data encoded electrical signal for generating an AMI modulated optical signal having three electric field levels, +/−E and 0, and two power levels, 0 and P, such that the resultant modulated signal is both amplitude and phase modulated.

2. The modulator of claim 1 further comprising:
a bipolar electrical coder for alternating the amplitude polarity of consecutive MARK pulses of a data encoded electrical signal to generate the bipolar data encoded electrical signal that is provided to the second input of the optical amplitude modulator.

3. The modulator of claim 2 wherein the bipolar electrical coder comprises:
an input terminal for receiving a signal source comprising a unipolar NRZ (non-return-to-zero) data encoded electrical signal having a MARK pulse represented by a high level voltage and an absence of a MARK pulse by a zero voltage;
a one-bit counter connected to the input terminal for receiving the NRZ (non-return-to-zero) data encoded electrical signal and providing a counter signal having a level inversion from a previous state to an alternate state of the zero voltage or the high level voltage, every time a MARK pulse is encountered and remaining at the previous state during the absence of a MARK pulse, such the first counter pulse rises from the zero voltage to the high level voltage from a zero voltage start during the first presence of a MARK pulse;
a first inverter comprising an inverted output terminal of the counter for providing an inverted counter signal such that the inverted counter signal has a level inversion from a previous state to an alternate state of the zero voltage or the high level voltage, every time a MARK pulse is encountered and remaining at the previous state during the absence of a MARK pulse, such the first inverted counter pulse falls from the high level voltage to the zero voltage from a high level voltage start during the first absence of a MARK pulse;
a first AND gate having input terminals connected to the inverted output terminal of the counter and to the signal source for ANDing the NRZ (non-return-to-zero) data encoded electrical signal with the counter signal to provide an odd pulse ANDed signal where only the odd pulses of the NRZ (non-return-to-zero) data encoded electrical signal are represented by a pulse;
a second AND gate connected to the input terminal for ANDing the NRZ (non-return-to-zero) data encoded electrical signal with the inverted counter signal to provide an even pulse ANDed signal where only the even pulses of the NRZ (non-return-to-zero) data encoded electrical signal are represented by a pulse;
a second inverter for changing the polarity of the even pulse ANDed signal such that the original positive-rising even pulse is represented by a negative falling pulse from the zero voltage to a negative high level voltage to provide a negative even pulse ANDed signal; and
a summer for adding the odd pulse ANDed signal with the negative even pulse ANDed signal to provide the bipolar data encoded electrical signal as an NRZ-AMI signal for transferring into an NRZ-AMI modulated optical signal having the three electric field levels, +/−E and 0, and two power levels 0 and P.

4. The modulator of claim 2 wherein the Mach-Zehnder modulator has a maximum MARK optical output pulse at a first voltage driving level +V, a maximum MARK optical output pulse at a second voltage driving level −V, a minimum optical output at a voltage level between the first and second voltage driving level and the phase of every maximum MARK optical output pulse is inverted alternately.

5. The modulator of claim 3, wherein the input terminal can also receive a unipolar RZ (return-to-zero) data encoded electrical signal having a MARK pulse represented by a high level voltage at a first portion of the bit period and a zero voltage at a remaining portion of the bit period (B) and an absence of a MARK pulse by the zero voltage to create an RZ-AMI optical signal at the output of the summer to provide an RZ-AMI signal as the output of the summer.

6. The modulator of claim 5 wherein the input terminal further comprises an NRZ to RZ converter for receiving the unipolar NRZ data encoded electrical signal at a second input terminal and converting the unipolar NRZ data encoded electrical signal to the unipolar RZ (return-to-zero) data encoded electrical signal having a MARK pulse represented by a high level voltage at the first portion of the bit period and a zero voltage at the remaining portion of the bit period (B) and an absence of a MARK pulse by the zero voltage.

7. A method of converting a unipolar voltage data stream into a bipolar optical data stream, the method comprising:
supplying a continuous optical signal to a modulator, wherein the modulator has a maximum MARK optical power output at a first voltage driving level +V, a maximum MARK optical power output at a second voltage driving level −V, a minimum optical power output at a voltage level between the first and second voltage driving level and the phase of every maximum MARK optical output pulse is inverted alternately;
encoding a unipolar voltage data stream to provide an encoded bipolar voltage data stream; and
driving the modulator with the encoded bipolar voltage data stream to generate a bipolar optical data stream such that there will be a minimum optical power output when the encoded bipolar voltage data stream stays at a midlevel between the first and the second voltage level.

8. The method of claim 7, wherein the encoding step comprises alternate MARK inversion (AMI) encoding.

9. The method of claim 7, wherein the encoding step comprises alternate MARK inversion (AMI) encoding and converting an NRZ unipolar signal to an RZ bipolar signal.

10. A unipolar electrical to bipolar optical converter, the converter comprising:
a bipolar electrical coder for alternating the amplitude polarity of consecutive MARK pulses of a data encoded electrical signal to generate a bipolar data encoded electrical signal; and
an electrical to optical modulator having an optical input for receiving a continuous optical signal, an electrical input for receiving the bipolar data encoded electrical signal, and an optical output for providing an AMI modulated optical signal having three optical electric field levels, +/−E and 0, and two optical power levels, 0 and P, when the bipolar data encoded electrical signal is applied to the electrical to optical modulator such that the resultant alternate electric fields of +/−E are in a form of phase shift keying.

11. The optical converter of claim 10 wherein the electrical to optical modulator comprises an optical amplitude modulator and the modulator having the electrical input for receiving a bipolar NRZ (non-return-to-zero) data encoded electrical signal such that the modulator converts the bipolar NRZ electrical signal to a bipolar NRZ optical signal for optical transmission in an amplitude modulated form.

12. The optical converter of claim 11 wherein the bipolar electrical coder comprises an NRZ-AMI encoder for receiving a unipolar NRZ data encoded electrical signal and generating a bipolar NRZ data encoded electrical signal in synchronism with a transmission bit rate clock signal.

13. The optical converter of claim 10 wherein the bipolar electrical coder comprises an AMI encoder for receiving a unipolar RZ data encoded electrical signal and generating a bipolar RZ data encoded electrical signal in synchronism with a transmission bit rate clock signal.

14. The optical converter of claim 10 wherein the bipolar electrical coder comprises an RZ-AMI encoder for receiving a unipolar NRZ data encoded electrical signal and generating a bipolar RZ data encoded electrical signal in synchronism with a transmission bit rate clock signal.

15. The optical converter of claim 10 wherein the electrical to optical modulator comprises a Mach-Zehnder interferometer.

16. The optical converter of claim 10 further comprising a laser for generating the continuous optical signal for use of the converter as a transmitter.

17. The optical converter of claim 10, wherein the bipolar electrical coder comprises an NRZ-AMI encoder having a limited bandwidth for generating an NRZ unipolar data encoded electrical signal with finite rise and fall times to a bandlimited NRZ bipolar data encoded electrical signal at the electrical input of the electrical to optical modulator.

18. The optical converter of claim 17 wherein the electrical to optical modulator comprises a Mach-Zehnder interferometer for converting the NRZ bipolar data encoded electrical signal at the electrical input to an NRZ-AMI modulated optical signal comprising a pseudo RZ modulated optical signal in optical form at the optical output.

19. The optical converter of claim 10, wherein the bipolar electrical coder comprises an NRZ to RZ converter coupled to an AMI encoder.

20. The optical converter of claim 19, wherein the NRZ to RZ converter comprises a data rate clocked AND gate.
